(19) United States
(12) Patent Application Publication
(10) Pub. No.: US 2014/0016172 A1
(43) Pub. Date: Jan. 16, 2014

(54) Mach-Zehnder Modulator Drive Level Optimization

(71) Applicant: Oclaro, Inc., San Jose, CA (US)

(72) Inventors: Sunil Kumar Singh Khatana, Sunnyvale, CA (US); Lee Dardis, San Jose, CA (US)

(21) Appl. No.: 13/939,489

(22) Filed: Jul. 11, 2013

Related U.S. Application Data
(60) Provisional application No. 61/671,414, filed on Jul. 13, 2012.

(51) Int. Cl. G02F 1/01

(52) U.S. Cl. CPC G02F 1/0121
USPC 359/239

(57) ABSTRACT

A method for determining, by a modulator assembly, an optimal drive point for a Mach-Zehnder modulator (MZM). The modulator assembly applies an electrical modulation signal to the MZM to modulate an optical input signal and create a modulated optical output signal, the modulated optical output having a spectrum that includes a first and third harmonic. The modulator assembly measures the difference in magnitude between the first harmonic and the third harmonic as the amplitude of the electrical modulation signal is varied, and determines a value for the amplitude of the electrical modulation signal that corresponds to a maximum difference between the first harmonic and the third harmonic.

### CROSS-REFERENCE TO RELATED APPLICATION(S)

This application claims priority under 35 U.S.C. §119(e) to U.S. Provisional Patent Application Ser. No. 61/671,414, titled “MZM Drive Level Optimization,” filed on Jul. 13, 2012. The subject matter of the foregoing is incorporated herein by reference in its entirety.

### BACKGROUND

1. Field of Disclosure

This disclosure relates to optimizing the drive signal amplitude in a Mach-Zehnder optical modulator.

2. Description of the Related Art

Modulation may be imparted to a continuous wave (CW) optical signal using a Mach-Zehnder modulator (MZM). When used this way, the MZM is often called data modulator. MZMs are components of fiber-optic communications systems that are being designed to operate at 100 gigabits per second over distances of 2,000 kilometers or more.

An electrical signal applied to a MZM generates a modulated optical output. Differential phase-shift keying (DPSK), duobinary, and quadrature phase-shift keying (QPSK) optical signals may be created in this way. However, if the amplitude of the electrical driving signal is either greater than or less than an optimum value, 2V_{π}, then the optical output of the MZM will not give optimum performance. Temperature, aging, and variations among individual devices can cause variations in 2V_{π} from one MZM to another. This leads to less than optimum performance in terms of Bit Error Rate if the amplitude of the electrical driving signal is not adjusted accordingly.

### SUMMARY

In one embodiment, a method for determining an optimal drive point for a Mach-Zehnder modulator (MZM). An electrical sinusoidal modulation signal is applied to the MZM to modulate an optical input signal and create a modulated optical output signal, the modulated optical output having a spectrum that includes a first and third harmonic. The difference in magnitude between the first harmonic and the third harmonic is measured as the amplitude of the electrical modulation signal is varied. A value for the amplitude of the electrical modulation signal is determined that corresponds to a maximum difference between the first harmonic and the third harmonic.

In another embodiment, a non-transitory computer-readable storage medium storing executable computer program instructions for determining an optimal drive point of a Mach-Zehnder modulator (MZM), the instructions executable to perform steps that comprise: applying an electrical modulation signal to the MZM to modulate an optical input signal and create a modulated optical output signal, the modulated optical output having a spectrum that includes a first and third harmonic. Measuring the difference in magnitude between the first harmonic and the third harmonic as the amplitude of the electrical modulation signal is varied. Determining a value for the amplitude of the electrical modulation signal that corresponds to a maximum difference between the first harmonic and the third harmonic.

### BRIEF DESCRIPTION OF DRAWINGS

FIG. 1 is a block diagram of an example modulator assembly according to an embodiment.

FIG. 2 is an example graph of the transfer function of a Mach-Zehnder modulator according to an embodiment.

FIG. 3A shows an example spectrum of a modulated optical output signal for an MZM driven by an optimum sinusoidal modulation signal according to an embodiment.

FIG. 3B shows an example optical output power for an MZM driven by the optimum sinusoidal modulation signal of FIG. 3A according to an embodiment.

FIG. 3C shows an example modulation signal amplitude for an MZM driven by the optimum sinusoidal modulation signal of FIG. 3A according to an embodiment.

FIG. 4A shows an example spectrum of a modulated optical output signal for an MZM driven by a less-than-optimum sinusoidal modulation signal according to an embodiment.

FIG. 4B shows an example optical output power for an MZM driven by the less-than-optimum sinusoidal modulation signal of FIG. 4A according to an embodiment.

FIG. 4C shows an example modulation signal amplitude for an MZM driven by a less-than-optimum modulation sinusoidal signal of FIG. 4A according to an embodiment.

FIG. 5A shows an example spectrum of a modulated optical output signal for an MZM driven by a greater-than-optimum sinusoidal modulation signal according to an embodiment.

FIG. 5B shows an example optical output power for an MZM driven by the greater-than-optimum sinusoidal modulation signal of FIG. 5A according to an embodiment.

FIG. 5C shows an example modulation signal amplitude for an MZM driven by the greater-than-optimum sinusoidal modulation signal of FIG. 5A according to an embodiment.

FIG. 6A shows an example optical spectrum of an MZM output plotted against a linear scale according to an embodiment.

FIG. 6B shows the optical spectrum of FIG. 6A plotted against a logarithmic scale according to an embodiment.

FIG. 7 shows an example calibration curve plotting the difference between first and third harmonics versus modulation signal amplitude divided by the halfwave voltage according to an embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

The optimum drive level for an MZM may be determined by monitoring the amplitude of the first and third harmonics in the optical spectrum of the modulator's output. The drive level (i.e., the amplitude of the electrical modulating signal is optimum when the difference amplitude between the first and third harmonics is maximized. This simple criterion is convenient for calibrating MZMs during production or adjusting them as they age or are subject to temperature variations or other environmental disturbances. Methods for adjusting the MZM drive level based on this criterion work best with drive signals having frequencies exceeding 10 GHz. Example data and a theoretical justification for the criterion are described below.

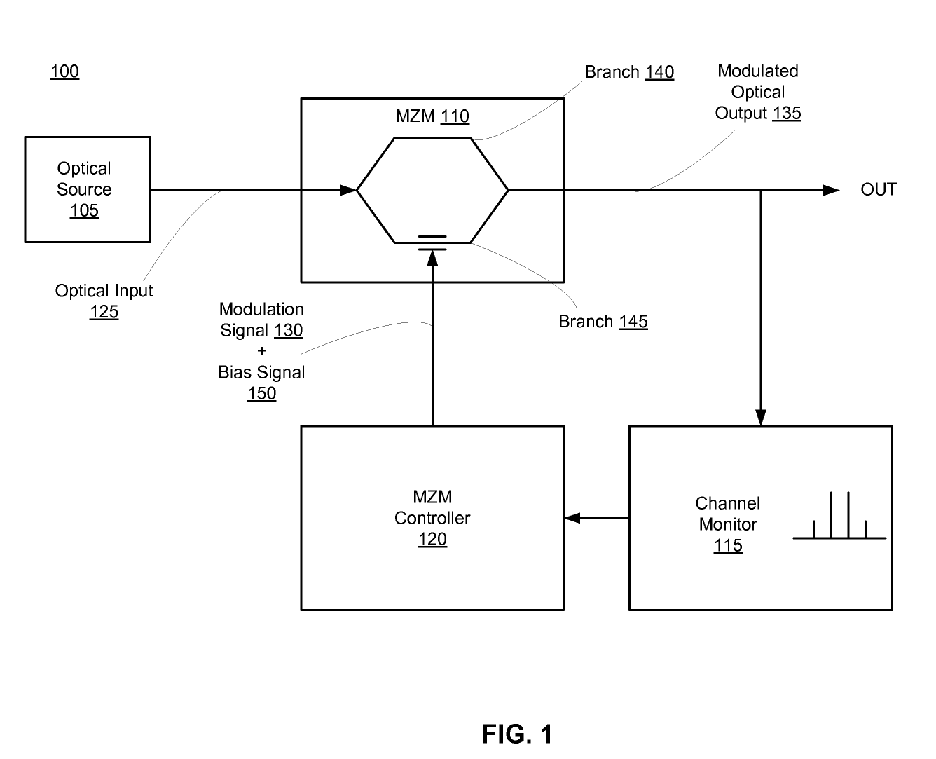

FIG. 1 is a block diagram of an example modulator assembly 100 according to an embodiment. The assembly 100 includes an optical source 105, a Mach-Zehnder modulator (MZM) 110, a channel monitor 115, and a MZM controller 115.

The optical source 105 is a laser source used to produce one or more output beams (e.g., optical input 125) of optical radiation at a particular frequency. To produce the output beam(s), the optical source 105 may include one or more laser chips (e.g., laser diodes). Additionally, one or more of the laser chips may be composed of a plurality of sections. For example, the optical source 105 may contain a single monolithic laser chip composed of a plurality of sections. The sections are different parts of the laser chip, e.g., the gain media, tuning, phase, amplifier, etc. The one or more laser chips may be chosen to produce frequencies of optical radiation useful for particular applications. For example, for some telecommunication applications, the frequencies of the optical radiation produced by the one or more laser chips may be spread across the C-band.

The MZM 110 modulates the optical input 125 with an electrical modulation signal 130 to create a modulated optical output 135. The MZM 110 is an interferometer that splits the optical input 125 and passes it along two branches 140,145, with variable retardation in branch 145. The MZM 110 is driven by the modulation signal 130, and biased by an electrical bias signal 150. The amount of retardation is determined by the modulation signal 130. The modulation signal 130, when applied to the branch 140 varies the refractive index of branch 130 and hence the amount of interference between the split optical signals when they recombine to create the modulated optical output 135. In some embodiments, the MZM 110 may include components (e.g., branches 140, 145) composed from, e.g. LiNbO₃, InP, or GaAs.

The modulation signal 130 generally carries the data to be modulated. When determining optimal drive conditions (i.e., optimal amplitude for the modulation signal 130) the modulation signal is a sinusoidal electrical signal. Additionally, in some embodiments, when determining optimal drive conditions the frequency of the sinusoidal modulation signal 130 is preferably close to half the data rate (e.g., if the data rate is 20 Gb/s the frequency of the modulation signal 130 may be 10 GHz).

The channel monitor 115 measures a frequency spectrum of the modulated optical output 135. The channel monitor 115 may be, for example, an optical spectrum analyzer or some other device capable of measuring the frequency spectrum of an optical signal. Specifically, the channel monitor 115 measures at least the first and third harmonics of the modulated optical output 135. The channel monitor 115 provides the frequency spectrum to the MZM controller 120.

In some embodiments, the MZM controller 120 is configured to adjust the values of the bias signal 150 and/or the modulation signal 130 based on the measured frequency spectrum of the modulated optical output 135. In some embodiments, the MZM controller 120 is configured to identify an optimal value for the bias signal 150 by identifying a range of voltage values that cause the optical signals in the branches 140 and 145 to range from being in phase to π radians out of phase. Additionally, in some embodiments (e.g., where components of the MZM 110 are composed of LiNbO3) a feedback system may be used to maintain the bias single 150 at a particular value. In alternate embodiments, the bias signal 150 may be control led using a separate bias controller.

The MZM controller 120 is configured to identify an optimal value (i.e., optimal drive point) for the modulation signal 130. The optimal drive point corresponds to a value of the amplitude of the modulation signal 130 that results in a maximum difference between the first harmonic and a third harmonic of the modulated optical output 135. In some embodiments, the MZM controller 120 varies (e.g., scans across a range of voltage values) the amplitude of the modulation signal 130 while monitoring the values of the generated first and third harmonics. For example, the MZM controller 120 may scan across a range of voltage values for the amplitude of the modulation signal 130. In some embodiments, an initial amplitude value may be selected that is thought to be near the optimal drive point. The MZM controller 120 may then adjust the amplitude value of the amplitude modulation signal 130 such that the difference in the magnitudes of the first and third harmonics is increasing. The MZM controller 120 continues to adjust the amplitude value until a maximum value of the difference in magnitudes of the first and third harmonics occurs. The MZM controller 120 may adjust the amplitude values in increments small enough to determine the maximum value (e.g., 1/10 of expected V_{π}) of the difference in magnitudes of the first and third harmonics.

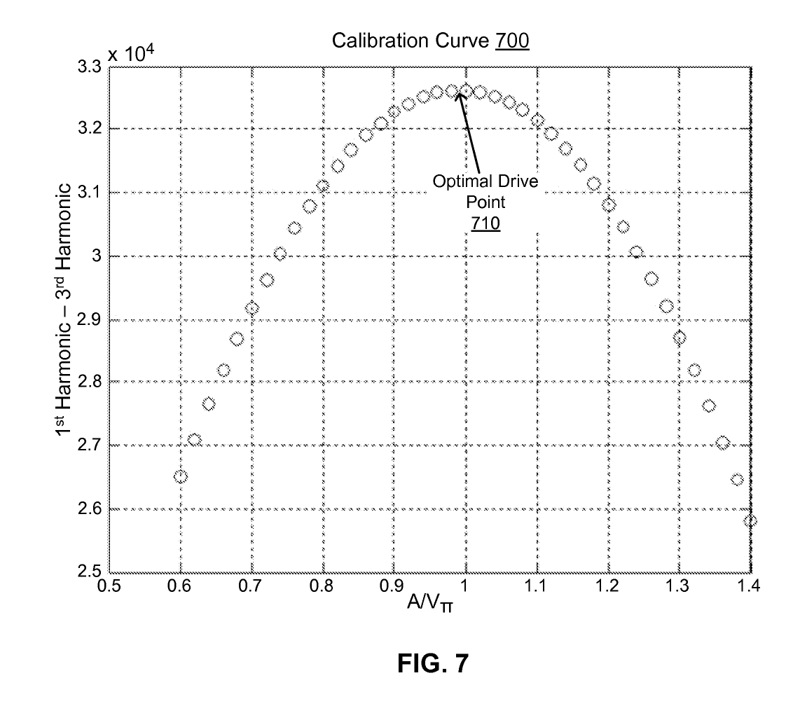

The MZM controller 120 may generate calibration data by mapping the difference in a first and third harmonic to an associated amplitude of the modulation signal 130 over a range of amplitude values. The generated calibration data may be stored in a lookup table, and in some embodiments may be plotted to form a calibration curve (e.g., as seen in FIG. 7 below). As mentioned above, the amplitude of the modulation signal 130 that corresponds to the maximum value of the differences in the first and third harmonics is the optimal drive point for the modulation signal 130. The MZM controller 120 then sets the modulation signal 130 to the optimal value. In some embodiments, the MZM controller 120 may determine the optimal values for the modulation signal 130 and/or the bias signal 150 during calibration, at start up, periodically during operation, or some combination thereof.

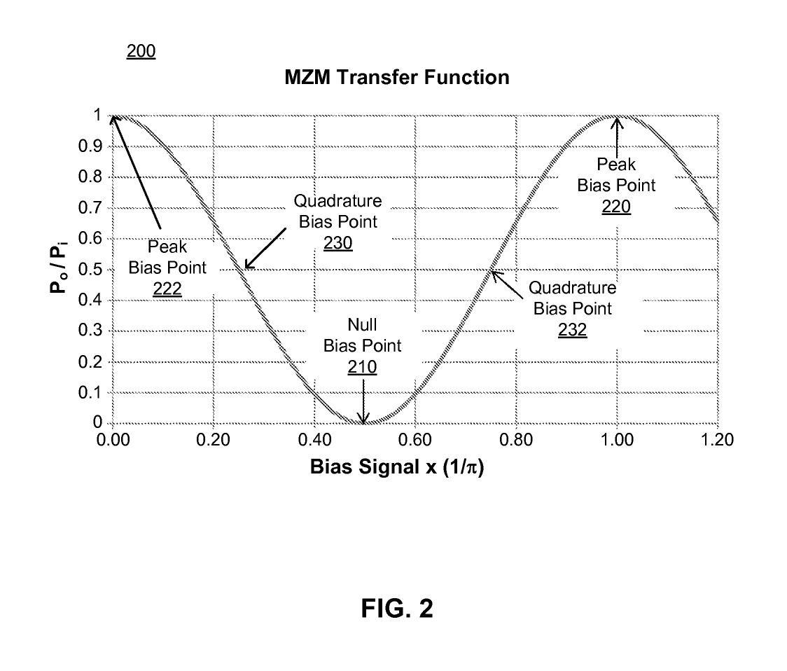

FIG. 2 is an example graph 200 of the transfer function of the MZM 110 according to an embodiment. The graph 200 shows the ratio of optical power output (Pₒ) divided by optical power input, Pᵢ, versus the bias signal 150 multiplied by 1/π (normalize units). A null bias point 210 corresponds to a voltage value where 1:1 destructive interference occurs between the optical signals that are recombined after exiting branches 140 and 145. The null bias point 210 occurs when the bias signal 150 is set to π/2 (normalized units). Peak bias points 220 and 222 corresponds to a voltage value where 1:1 constructive interference occurs between the optical signals recombined after branches 140 and 145. The peak bias points 220 and 220 occur when the bias signal 150 is set to π or 0 (normalized units), respectively. In some embodiments, the bias signal 150 is tuned to Quadrature bias points 230 or 232 during normal operation. The quadrature bias points 230 and 232 occur when the bias signal 150 is set to π/4 or 3π/4 (normalized units). For drive level optimization, the null bias point 210 is set to V=π/2 (normalized units). However, once the optimum drive level is established, other bias points may be used in modulator operation. In some embodiments, the bias signal 150 may be tuned to the null bias point 210, one of the peak bias points 220, 222, or one of the quadrature bias points 230, 232, during normal operation depending on the modulation format. Accordingly, the method herein is useful irrespective of bias point of the MZM 150.

The halfwave voltage, V_{π} (or Vpi), of an MZM is defined as the difference between the applied voltage (i.e., bias signal) at which the signals in each branch of the MZM are in phase and the applied voltage at which the signals are π radians out of phase. In other words, V_{π} is the voltage difference between maximum and minimum output signal power.

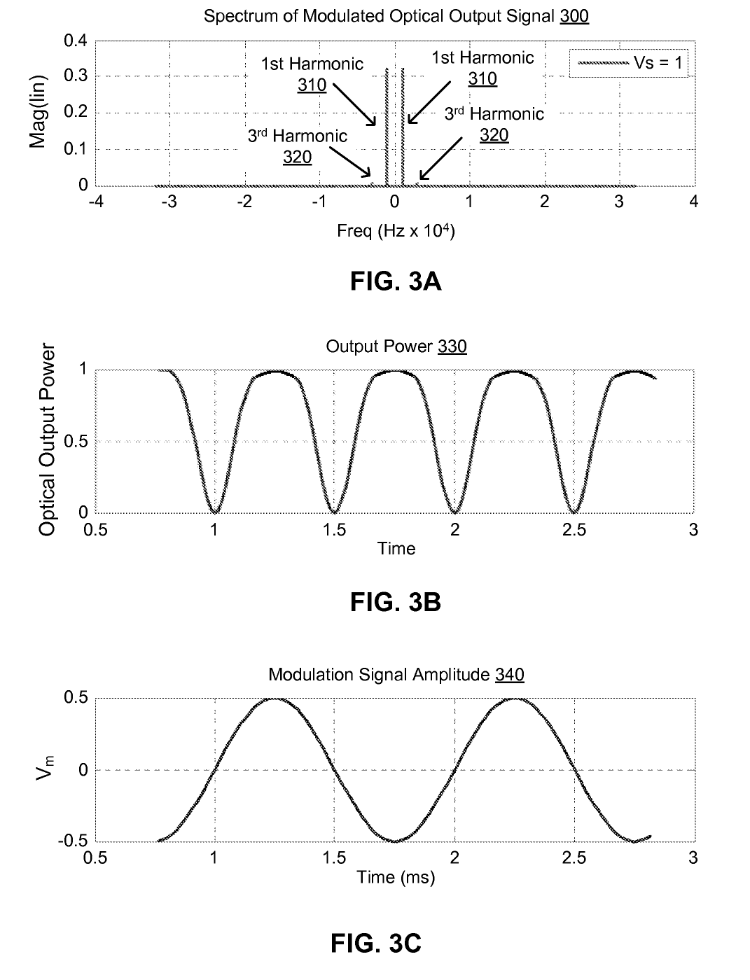

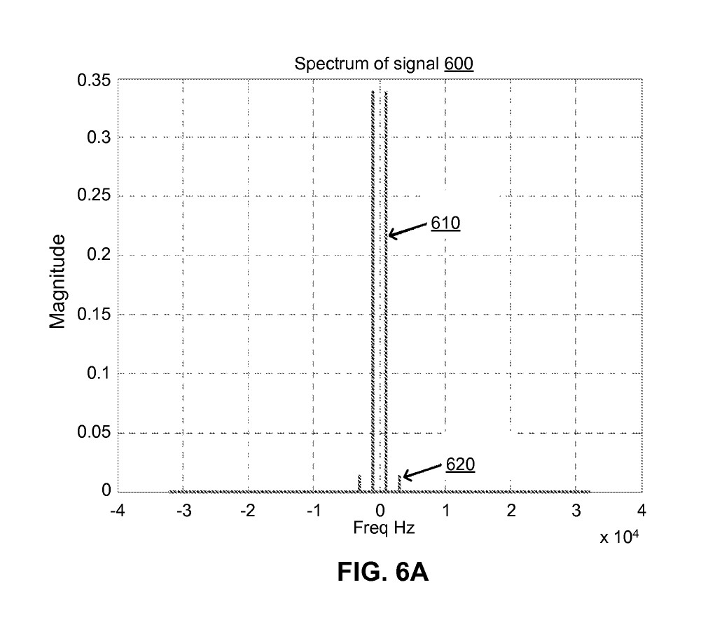

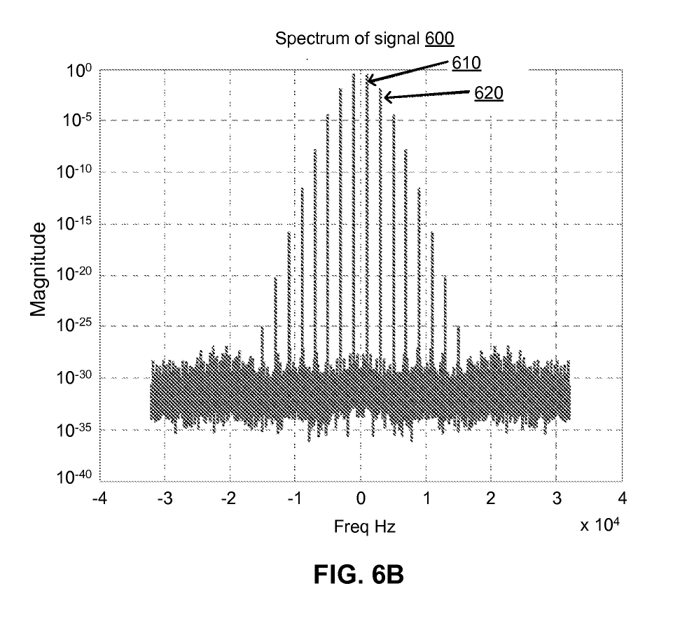

FIG. 3A shows an example spectrum 300 of a modulated optical output signal for an MZM driven by an optimum sinusoidal modulation signal according to an embodiment. The vertical axis is magnitude of the harmonics in linear units, and the horizontal axis is measured in frequency normalized to the center frequency of the modulated optical output signal. The spectrum 300 includes a positive and negative set of first harmonics 310 and third harmonics 320. As discussed below with respect to FIGS. 6A and 6B, the spectrum 300 may also include additional harmonics.

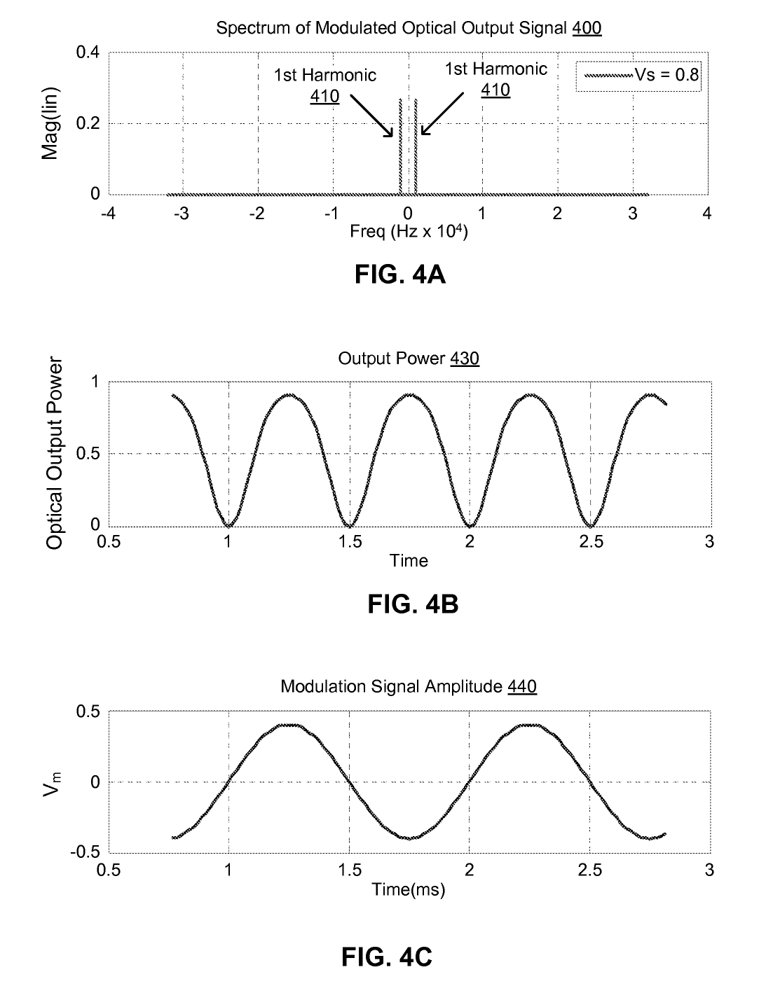

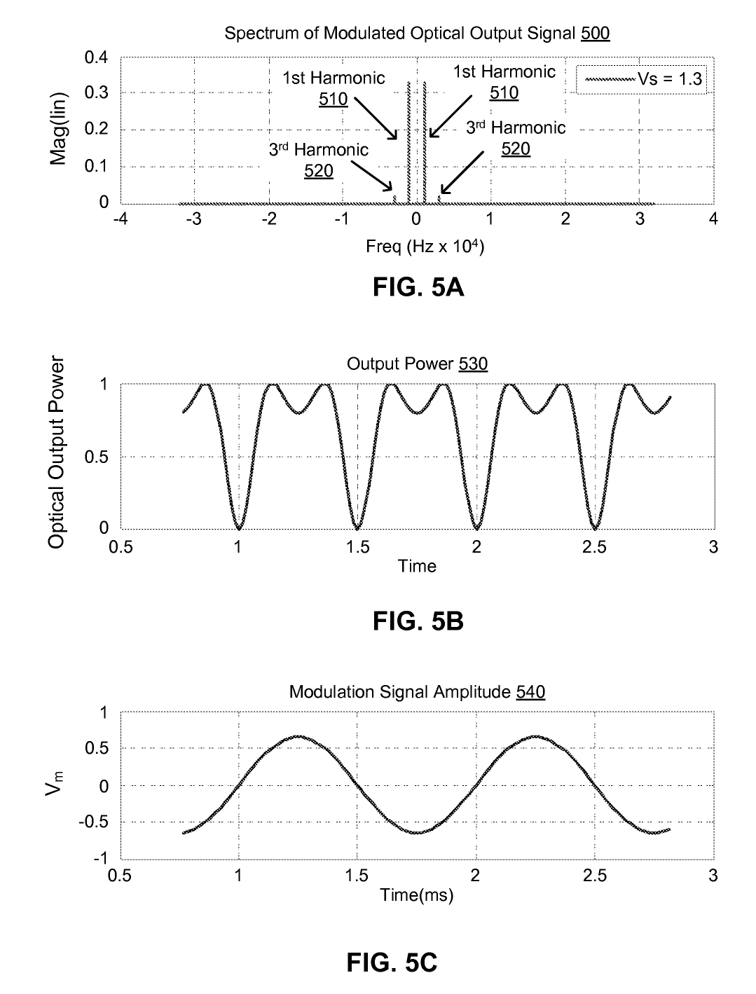

FIG. 3B shows an example optical output power 330 for an MZM driven by the optimum sinusoidal modulation signal of FIG. 3A according to an embodiment. In FIG. 3B (as well as FIGS. 4B and 5B), optical output power is:

Optical Output Power=Cos²(Vₘ+V_{b}) (1)

where Vₘ is the modulation signal 130 and V_{b} is the bias signal 150.

FIG. 3C shows an example modulation signal amplitude 340 for an MZM driven by the optimum sinusoidal modulation signal of FIG. 3A according to an embodiment. In FIG. 3C (as well as FIGS. 4C and 5C), the modulation signal, Vₘ, is:

$${V}_{m} = ( \frac{1}{2 {V}_{π}} ) A Sin ( ω t ) \qquad ( 2 )$$

where A is the amplitude of the modulation signal and ω is the angular frequency. In the embodiment described by FIG. 3C, A equals V_{π}.

FIG. 4A shows an example spectrum 400 of a modulated optical output signal for an MZM driven by a less-than-optimum sinusoidal modulation signal according to an embodiment. The vertical axis is magnitude of the harmonics in linear units, and the horizontal axis is measured in frequency normalized to the center frequency of the modulated optical output signal. The spectrum 400 includes a positive and negative set of first harmonics 410. Additional harmonics may be present (e.g., third harmonics), however, they are reduced in magnitude such that they are not visible at the displayed scale. FIG. 4B shows an example optical output power 430 for an MZM driven by the less-than-optimum sinusoidal modulation signal of FIG. 4A according to an embodiment. FIG. 4C shows an example modulation signal amplitude 440 for an MZM driven by a less-than-optimum modulation sinusoidal signal of FIG. 4A according to an embodiment. In the embodiment described by FIG. 4C, A equals 0.8V_{π}. Note, that the set of first harmonics 410 are reduced in magnitude when compared with the set of first harmonics 310 in FIG. 3A, and the optical output power 430 is less than the optical output power 340 displayed in FIG. 3B.

FIG. 5A shows an example spectrum 500 of a modulated optical output signal for an MZM driven by a greater-than-optimum sinusoidal modulation signal according to an embodiment. The vertical axis is magnitude of the harmonics in linear units, and the horizontal axis is measured in frequency normalized to the center frequency of the modulated optical output signal. The spectrum 500 includes a positive and negative set of first harmonics 510 and third harmonics 520. FIG. 5B shows an example optical output power 530 for an MZM driven by the greater-than-optimum sinusoidal modulation signal of FIG. 5A according to an embodiment. FIG. 5C shows an example modulation signal amplitude 540 for an MZM driven by the greater-than-optimum sinusoidal modulation signal of FIG. 5A according to an embodiment. In the embodiment described by FIG. 5C, A equals 1.3V_{π}. Note, that the set of first harmonics 510 and third harmonics 520 have increased in magnitude when compared with the set of first harmonics 310 and set of third harmonics 320 in FIG. 3A. While the magnitudes of the first harmonics 510 and the third harmonics 520 have increased with respect to harmonics 310 and 320 respectively, the difference between a first harmonic 510 and a third harmonic 520 is actually less than a difference between a first harmonic 310 and a third harmonic 320. Additionally, the optical output power 530 behaves differently than the optical output power 340 displayed in FIG. 3B.

In comparing FIGS. 3A-C, 4A-C, and 5A-C it is apparent that the shape of the output power waveform changes with modulation signal drive level and these changes are reflected in the different optical spectra shown in each case. In particular, the amplitudes of the first and third harmonics of the optical output are different in each case.

FIG. 6A shows an example optical spectrum 600 of an MZM output plotted against a linear scale according to an embodiment. The vertical axis is magnitude of the harmonics in linear units, and the horizontal axis is measured in frequency normalized to the center frequency of a modulated optical output signal 135. The spectrum 600 includes a positive and negative set of first harmonics 610 and third harmonics 620. The spectrum 600 may also include additional sets of harmonics that are not visible in a linear scale.

FIG. 6B shows the optical spectrum 600 of FIG. 6A plotted against a logarithmic scale according to an embodiment. The logarithmic scale of FIG. 6B shows that the optical spectrum 600 contains many higher order harmonics even though they may be so small in amplitude that they do not appear in the linear plot of FIG. 6A.

FIG. 7 shows an example calibration curve 700 plotting the difference between first and third harmonics versus modulation signal amplitude divided by the halfwave voltage according to an embodiment. The units of the horizontal axis are normalized such that the calibration curve 700 has a maximum at optimal drive point 710 when the amplitude of the modulation signal 130 has a voltage value of V. The scale of the vertical axis is arbitrary.

### Additional Configuration Considerations

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Additionally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

Finally, in the claims, reference to an element in the singular is not intended to mean “one and only one” unless explicitly stated, but rather is meant to mean “one or more.”In addition, it is not necessary for a device or method to address every problem that is solvable by different embodiments of the invention in order to be encompassed by the claims.

1. An method comprising:
applying an electrical modulation signal to a Mach-Zehnder modulator (MZM) to modulate an optical input signal and create a modulated optical output signal, the modulated optical output having a spectrum that includes a first and third harmonic;
measuring the difference in magnitude between the first harmonic and the third harmonic as the amplitude of the electrical modulation signal is varied; and
determining a value for the amplitude of the electrical modulation signal that corresponds to a maximum difference between the first harmonic and the third harmonic.

2. The method of claim 1, wherein the electrical modulation signal is sinusoidal.

3. The method of claim 2, wherein the electrical modulation signal has a frequency of at least 10 GHz.

4. The method of claim 1, further comprising:
applying an electrical bias voltage to the MZM, such that the MZM is biased at a null point.

5. The method of claim 1, further comprising:
setting the amplitude of the electrical modulation signal to the determined value.

6. The method of claim 1, wherein measuring the difference in magnitude between the first harmonic and the third harmonic as the amplitude of the electrical modulation signal is varied, comprises:
setting the amplitude of the amplitude modulation signal to an initial value;
adjusting the amplitude of the amplitude modulation signal such that the difference in the magnitudes of the first and third harmonics is increasing in value.

7. A non-transitory computer-readable storage medium storing executable computer program instructions for determining an optimal drive point of a Mach-Zehnder modulator (MZM), the instructions executable to perform steps comprising:
applying an electrical modulation signal to the MZM to modulate an optical input signal and create a modulated optical output signal, the modulated optical output having a spectrum that includes a first and third harmonic;
measuring the difference in magnitude between the first harmonic and the third harmonic as the amplitude of the electrical modulation signal is varied; and
determining a value for the amplitude of the electrical modulation signal that corresponds to a maximum difference between the first harmonic and the third harmonic.

8. The computer-readable medium of claim 7, wherein the electrical modulation signal is sinusoidal.

9. The computer-readable medium of claim 8, wherein the electrical modulation signal has a frequency of at least 10 GHz.

10. The computer-readable medium of claim 7, further comprising:
applying an electrical bias voltage to the MZM, such that the MZM is biased at a null point.

11. The computer-readable medium of claim 7, further comprising:
setting the amplitude of the electrical modulation signal to the determined value.

12. The computer-readable medium of claim 7, wherein measuring the difference in magnitude between the first harmonic and the third harmonic as the amplitude of the electrical modulation signal is varied, comprises:
setting the amplitude of the amplitude modulation signal to an initial value;
adjusting the amplitude of the amplitude modulation signal such that the difference in the magnitudes of the first and third harmonics is increasing in value.
